(19) United States
(12) Patent Application Publication
(10) Pub. No.: US 2010/0180440 A1
(43) Pub. Date: Jul. 22, 2010

(54) METHOD FOR MANUFACTURING INK-JET HEAD

(75) Inventors: Boum-Seock Kim, Suwon-si (KR); Jae-Woo Joung, Suwon-si (KR); Ju-Hwan Yang, Suwon-si (KR); Young-Seuck Yoo, Seoul (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 12/499,582

(22) Filed: Jul. 8, 2009

(30) Foreign Application Priority Data
Jan. 21, 2009 (KR) 10-2009-0005110

(51) Int. Cl. B23P 17/00

(52) U.S. Cl. 29/890.1

(57) ABSTRACT

A method for manufacturing an ink jet head is disclosed. The method can include: forming a separation trough in one surface of each of a first piezoelectric element and a second piezoelectric element; attaching the first and the second piezoelectric elements together with the separation troughs of the first and the second piezoelectric elements facing each other; processing the other surface of the first piezoelectric element such that the separation trough is exposed; attaching the other surface of the first piezoelectric element to the membrane; and processing the other surface of the second piezoelectric element such that the separation trough is exposed. By utilizing certain embodiments of the invention, the actuators of an ink jet head can be manufactured with the piezoelectric elements separated from one another, without applying excessive stresses on the membrane.

### CROSS-REFERENCE TO RELATED APPLICATIONS

This application claims the benefit of Korean Patent Application No. 10-2009-0005110, filed with the Korean Intellectual Property Office on Jan. 21, 2009, the disclosure of which is incorporated herein by reference in its entirety.

### BACKGROUND

1. Technical Field

The present invention relates to a method for manufacturing an ink-jet head.

2. Description of the Related Art

An ink-jet printer is a device that performs a printing operation by converting an electrical signal into a physical force to eject ink droplets through a number of nozzles. In recent times, the application of the ink-jet head has expanded beyond the graphic printing industry, to manufacturing printed circuit boards and electronic parts, such as LCD panels, etc.

Accordingly, various functions that have not been required in the conventional fields of graphic printing are now required in current ink jet printing applications for manufacturing electronic components, in which it is critically important to eject the ink with high precision and accuracy.

FIG. 1 is a front cross-sectional view of an ink-jet head 12 according to the related art. As in the example shown in FIG. 1, a conventional method may involve attaching a piezoelectric element 2 to a membrane 4 on a surface of the ink-jet head 12, and then performing a dicing process to form an independent actuator 3 over each chamber 6.

Here, the dicing process for fully severing each of the actuators 3 can apply a considerable amount of stress on the silicon substrate forming the membrane 4 of the ink-jet head 1. On the other hand, if the piezoelectric member 2 is not completely severed because of this risk, each of the actuators will remain connected, as in the example shown in FIG. 1. This can result in crosstalk caused by vibrations transferred from adjacent chambers 6.

Furthermore, if the dicing process is performed with two dicing actions using a thin saw blade, because of the risk of large stresses applied to the silicon substrate of the ink-jet head, residue 8 from the piezoelectric element may be left in the form of a wall between two adjacent actuators 3. Such residue 8 can also be a cause of crosstalk.

### SUMMARY

An aspect of the invention provides a method for manufacturing an ink-jet head that includes actuators that produce less crosstalk.

Another aspect of the invention provides a method for manufacturing an ink-jet head that includes a chamber for holding ink and a membrane formed on one side of the chamber. The method can include: forming a separation trough in one surface of each of a first piezoelectric element and a second piezoelectric element; attaching the first and the second piezoelectric elements together with the separation troughs of the first and the second piezoelectric elements facing each other; processing the other surface of the first piezoelectric element such that the separation trough is exposed; attaching the other surface of the first piezoelectric element to the membrane; and processing the other surface of the second piezoelectric element such that the separation trough is exposed.

Here, the method for manufacturing an ink-jet head can further include an operation of attaching the other surface of the second piezoelectric element to a carrier, before the operation of processing the other surface of the first piezoelectric element, and can also include an operation of separating the second piezoelectric element from the carrier, after the operation of processing the other surface of the first piezoelectric element and before the operation of attaching the other surface of the first piezoelectric element to the membrane:

The operations for processing the other surfaces of the first and second piezoelectric elements can be performed by abrading the other surfaces of the first and second piezoelectric elements, respectively.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is a cross-sectional view illustrating a process of dicing a piezoelectric element according to the related art.

FIG. 2 is a side cross-sectional view illustrating a portion of an ink-jet head according to an embodiment of the invention.

FIG. 3 is a flowchart illustrating a method for manufacturing an ink-jet according to an embodiment of the invention.

FIG. 4 and FIG. 5 are cross-sectional views illustrating processes of forming separation troughs in a first piezoelectric element and a second piezoelectric element according to an embodiment of the invention.

FIG. 6 is a cross-sectional view illustrating a process of attaching the first and second piezoelectric elements according to an embodiment of the invention.

FIG. 7 is a cross-sectional view illustrating a process of attaching the second piezoelectric element to a carrier according to an embodiment of the invention.

FIG. 8 is a cross-sectional view illustrating a process of abrading one surface of the first piezoelectric element according to an embodiment of the invention.

FIG. 9 is a cross-sectional view illustrating a process of attaching one surface of the first piezoelectric element to a membrane according to an embodiment of the invention.

FIG. 10 is a cross-sectional view illustrating a process of abrading the other surface of the second piezoelectric element according to an embodiment of the invention.

FIG. 11 is a cross-sectional view illustrating a process of forming electrodes on the first and second piezoelectric elements according to an embodiment of the invention.

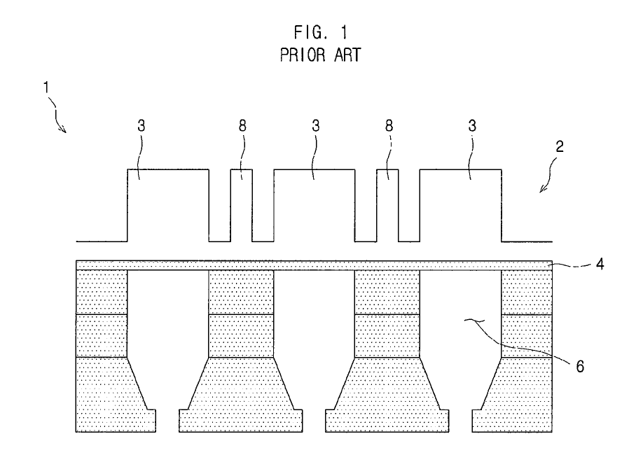

### DETAILED DESCRIPTION

The method for manufacturing an ink jet head according to certain embodiments of the invention will be described below in more detail with reference to the accompanying drawings. Those components that are the same or are in correspondence are rendered the same reference numeral regardless of the figure number, and redundant descriptions are omitted.

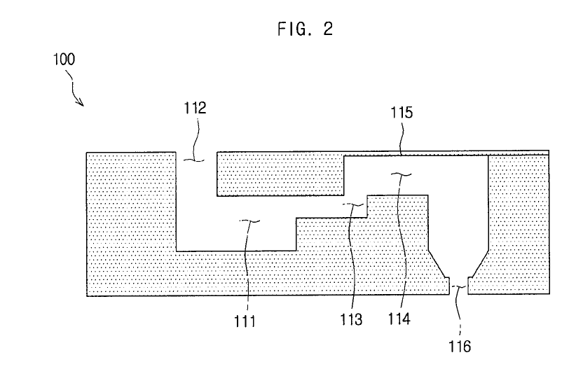

FIG. 2 is a side cross-sectional view illustrating a portion of an ink jet head according to an embodiment of the invention. As in the example shown in FIG. 2, the ink-jet head 100 can include a reservoir 111, a restrictor 113, a chamber 114, a membrane 115, a nozzle 116, etc.

The reservoir 111 can hold the ink and can supply the ink through the restrictor 113 to the chamber 114. The reservoir 111 can be supplied with the ink from outside the ink-jet head 100 through an inlet 112.

The restrictor 113 can connect the reservoir 111 with the chamber 114, and can serve as a channel through which ink may be supplied from the reservoir 111 to the chamber 114.

The restrictor 113 can be formed with a smaller cross-section than that of the reservoir 111. When a piezoelectric element 190 applies pressure to the chamber 114, the restrictor 113 can control the flow of ink from the reservoir 111 to the chamber 114.

One side of the chamber 114 can be connected with the restrictor 113, while the other side can be connected with the nozzle 116. The chamber 114 can be formed inside the ink-jet head 100 for holding the ink, and can have one side covered by the membrane 115.

The ink-jet head 100 can include a multiple number of chambers 114 formed in a row along the lengthwise direction. Accordingly, there can also be a multiple number of reservoirs 111 extending lengthwise, as well as multiple restrictors 113 formed between the respective chambers 114 and reservoirs 111.

A nozzle 116 can be coupled to the other side of each chamber 114, providing a passage through which ink held in the chamber 114 may be ejected to the exterior of the ink-jet head 100.

An actuator, which will be described later in more detail, can be coupled onto one side of the ink-jet head 100 corresponding to the position of the chamber 114, i.e. the upper portion of the membrane 115. The actuator can be configured to generate a vibration that is transferred to the chamber 114 by way of the membrane 115 and thus apply pressure to the chamber 114. For example, the actuator can include a piezoelectric element.

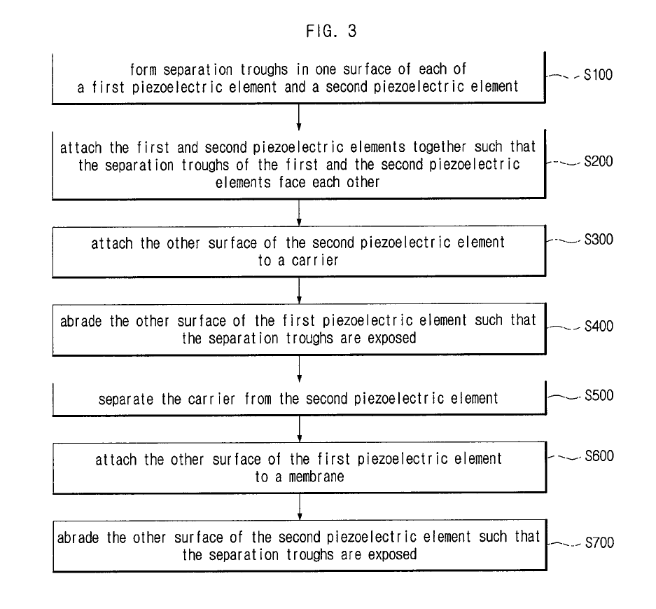

FIG. 3 is a flowchart illustrating a method for manufacturing an ink-jet according to an embodiment of the invention. As illustrated in FIG. 3, a method for manufacturing an ink-jet head according to an embodiment of the invention can include: forming separation troughs 212 and 222 in one surface of each of a first piezoelectric element 210 and a second piezoelectric element 220 (operation S100); attaching the first and second piezoelectric elements 210 and 220 such that the separation troughs 212 and 222 of the first and second piezoelectric elements 210 and 220 face each other (operation S200); processing the other surface of the first piezoelectric element 210 such that the separation troughs 212 are exposed (operation S400); attaching the other surface of the first piezoelectric element 210 to the membrane (operation S600); and processing the other surface of the second piezoelectric element 220 such that the separation troughs 222 are exposed (operation S700). By utilizing this method, the actuators of the ink jet head can be manufactured with the piezoelectric elements separated from one another, without applying stresses on the membrane.

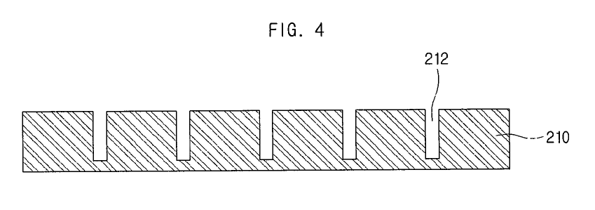

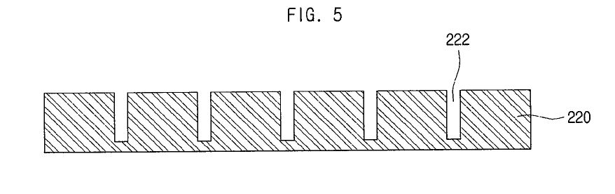

FIG. 4 and FIG. 5 are cross-sectional views illustrating the processes of forming separation troughs 212 and 222 in the first and second piezoelectric elements 210 and 220 according to an embodiment of the invention. As shown in FIGS. 4 and 5, the separation troughs 212 and 222 may first be formed in one surface of the first and second piezoelectric elements 210 and 220, respectively (operation S100).

The first and second piezoelectric elements 210 and 220 can be, for example, thick film piezoelectric materials. The first and second piezoelectric elements 210 and 220 may extend along the direction in which the multiple chambers of the ink jet head 100 are formed.

Here, the separation troughs 212 and 222 can be formed such that the first and second piezoelectric elements 210 and 220 are divided in accordance with the position of each of the chambers. That is, the separation troughs 212 and 222 can be formed such that the first and second piezoelectric elements 210 and 220 are segmented in equal sizes.

The separation troughs 212 and 222 can be formed using a dicing process, etc. The depth of a separation trough 212 and 222 can be greater than the thickness that the first and second piezoelectric elements 210 and 220 will ultimately have. The separation troughs 212 and 222 do not have to completely sever the first and second piezoelectric elements 210 and 220.

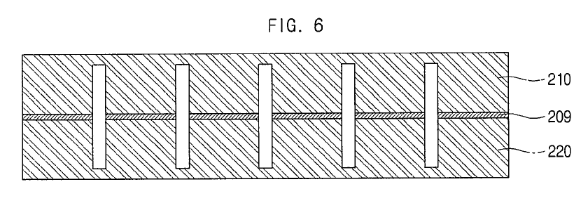

FIG. 6 is a cross-sectional view illustrating a process of attaching the first /and second piezoelectric elements 210 and 220 according to an embodiment of the invention. As illustrated in FIG. 6, the first and second piezoelectric elements 210 and 220 can be attached together, with the separation troughs 212 and 222 of the first and second piezoelectric elements 210 and 220 facing each other (operation S200).

After positioning the first and second piezoelectric elements 210 and 220 such that the separation troughs 212 and 222 of the first and second piezoelectric elements 210 and 220 are aligned, an adhesive 209 can be placed in-between, and the arrangement compressed, to attach the first and second piezoelectric elements 210 and 220 to each other. Here, the adhesive 209 can be applied in a small quantity so as not to obstruct the electrical connection between the first and second piezoelectric elements 210 and 220.

By attaching the first and second piezoelectric elements 210 and 220 with the separation troughs 212 and 222 of the first and second piezoelectric elements 210 and 220 aligned, a portion of the first piezoelectric element 210 and a portion of the second piezoelectric element 220 divided by separation troughs 212 and 222 can be combined to ultimately form a single actuator.

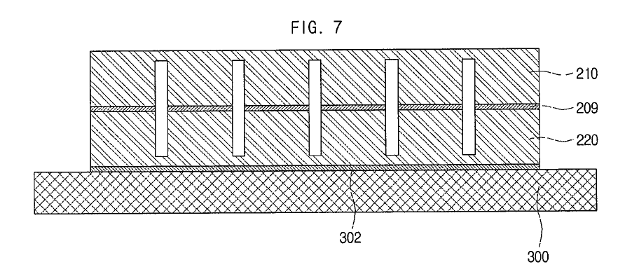

FIG. 7 is a cross-sectional view illustrating a process of attaching the second piezoelectric element 220 to a carrier 300 according to an embodiment of the invention. As illustrated in FIG. 7, the other surface of the second piezoelectric element 220 can be attached to the carrier 300 (operation S300).

The other surface of the second piezoelectric element 220 may be the portion where the separation troughs 222 are not formed; this portion can be attached to the carrier 300. The carrier 300 can be a component that temporarily supports the arrangement of the coupled first and second piezoelectric elements 210 and 220 to facilitate subsequent procedures. Use of the carrier 300 may thus be omitted or replaced by another method. A dummy silicon substrate, for example, can be used for the carrier 300.

The method of attaching the second piezoelectric element 220 and the carrier 300 may include applying an adhesive 302 between the other surface of the second piezoelectric element 220 and the carrier 300 and compressing. The adhesive 302 used here can be made from a material of which the adhesion may be lowered by reheating, etc., during a subsequent process.

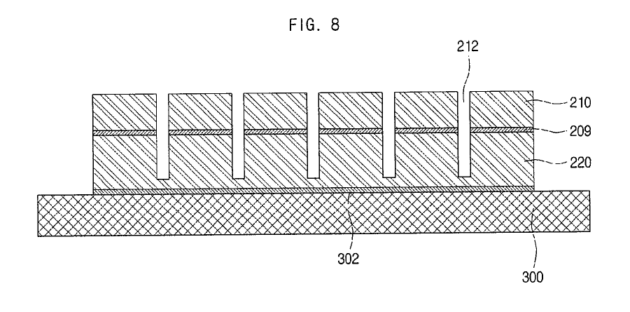

FIG. 8 is a cross-sectional view illustrating a process of abrading one surface of the first piezoelectric element 210 according to an embodiment of the invention. As illustrated in FIG. 8, the other surface of the first piezoelectric element 210 can be abraded such that the separation troughs 212 are exposed (operation S400).

The other surface of the first piezoelectric element 210 can be processed, by using a physical method such as abrasion, etc. to remove a portion of the first piezoelectric element 210. Of course, the processing may also be effected by using a chemical method such as etching, etc. to remove a portion of the first piezoelectric element 210.

Next, the carrier 300 can be detached from the second piezoelectric element 220 (operation S500). This operation can be performed by physically separating the second piezoelectric element 220 from the carrier 300, or by using a chemical method, including reheating, for example, to provide an environment in which the adhesion of the adhesive 302 cannot be maintained.

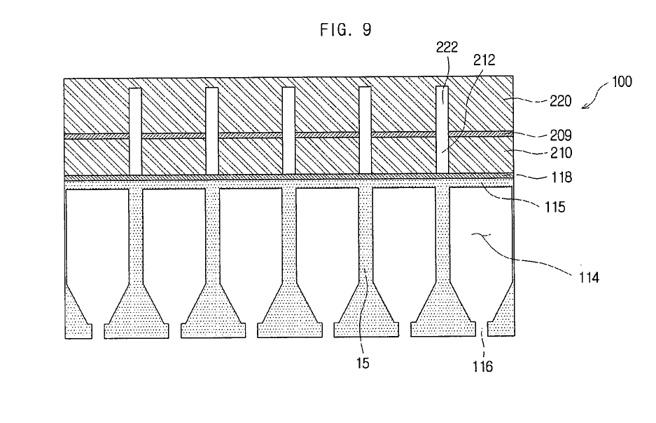

FIG. 9 is a cross-sectional view illustrating a process of attaching one surface of the first piezoelectric element 210 to the membrane 115 according to an embodiment of the invention. As illustrated in FIG. 9, the other surface of the first piezoelectric element 210 can be attached to the membrane 115 (operation S600).

The other surface of the first piezoelectric element 210 and the membrane 115 can be arranged to face each other, and then an adhesive can be positioned in-between, to attach the other surface of the first piezoelectric element 210 to the membrane 115.

Here, the portions of the first and second piezoelectric elements 210 and 220 divided by the separation troughs 212 and 222 can be arranged to coincide with the positions of the chambers 114. In other words, the first and second piezoelectric elements 210 and 220 can be attached on the membrane 115 in such a way that the separation troughs 212 and 222 coincide with the positions of the partitions 15 between the chambers 14.

A conductive metal layer 118 can be formed over the membrane 115 to be used as electrodes that provide electrical connection to the actuators.

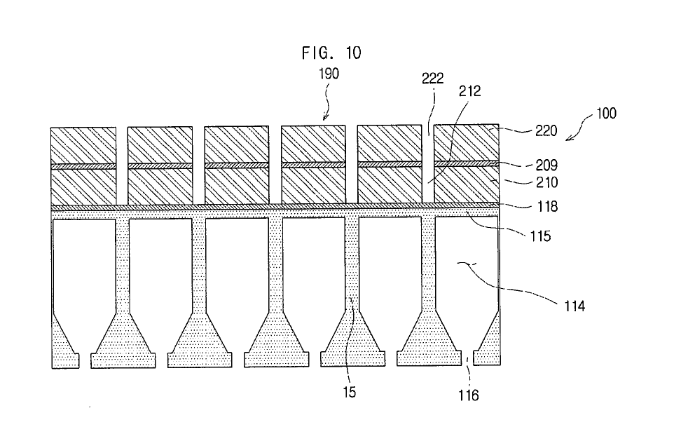

FIG. 10 is a cross-sectional view illustrating a process of abrading the other surface of the second piezoelectric element 220 according to an embodiment of the invention. As illustrated in FIG. 10, the other surface of the second piezoelectric element 220 can be abraded such that the separation troughs 212 and 222 are exposed (operation S700).

By abrading the other surface of the second piezoelectric element 220 to remove a portion of the other surface, the portions of the second piezoelectric element 220 divided by the separation troughs 222 can be separated completely. The portions of the first and second piezoelectric elements 210 and 220 as segmented by the separation troughs 212 and 222 may form independent actuators 190.

Thus, each of the actuators 190 may not be connected by any left-over piezoelectric material, and the method for manufacturing an ink-jet head 100 according to this embodiment may thus reduce the likelihood of crosstalk.

The abrading process can be performed to an extent that provides the sets of first and second piezoelectric elements 210 and 220 with the desired height, and in this manner, the thickness of the actuators 190 can be controlled. For example, when thinner actuators 190 are required, the height of the actuators 190 can be lowered during the abrading process, to lower the operating power and improve the frequency characteristics of the ink-jet head 100.

The abrading process can be performed using a physical method, such as abrasion, etc., to remove a portion of the second piezoelectric element 220, or can be performed using a chemical method, such as etching, etc., to remove a portion of the second piezoelectric element 220.

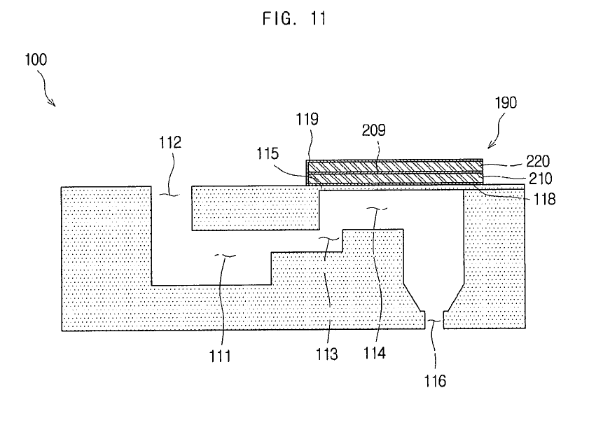

FIG. 11 is a cross-sectional view illustrating a process of forming electrodes 119 on the first and second piezoelectric elements 210 and 220 according to an embodiment of the invention. As illustrated in FIG. 11, electrodes 119 can be formed over the actuators 190 to provide electrical connection. The electrodes 119 can be electrically connected with the first and second piezoelectric elements 210 and 220.

The electrodes 119 can be formed over the other surface and a lateral surface of the second piezoelectric element 220 as well as on a lateral side of the first piezoelectric element 210. Thus, by stacking a thick film piezoelectric element and providing electrical connection to each of the first and second piezoelectric elements 210 and 220, the operating power of the actuators 190 can be lowered.

According to certain embodiments of the invention as set forth above, the actuators of an ink-jet head can be manufactured with the piezoelectric elements separated from one another, without applying excessive stresses on the membrane.

While the spirit of the invention has been described in detail with reference to particular embodiments, the embodiments are for illustrative purposes only and do not limit the invention. It is to be appreciated that those skilled in the art can change or modify the embodiments without departing from the scope and spirit of the invention.

What is claimed is:

1. A method for manufacturing an ink jet head comprising a chamber for holding ink and a membrane formed on one side of the chamber, the method comprising:
forming a separation trough in one surface of each of a first piezoelectric element and a second piezoelectric element;
attaching the first and the second piezoelectric elements together such that the separation troughs of the first and the second piezoelectric elements face each other;
processing the other surface of the first piezoelectric element such that the separation trough is exposed;
attaching the other surface of the first piezoelectric element to the membrane; and
processing the other surface of the second piezoelectric element such that the separation trough is exposed.

2. The method of claim 1, further comprising:
attaching the other surface of the second piezoelectric element to a carrier, before the processing of the other surface of the first piezoelectric element; and
separating the second piezoelectric element from the carrier, between the processing of the other surface of the first piezoelectric element and the attaching of the other surface of the first piezoelectric element to the membrane.

3. The method of claim 1, wherein the processing of the other surface of the first piezoelectric element is performed by abrading the other surface of the first piezoelectric element.

4. The method of claim 1, wherein the processing of the other surface of the second piezoelectric element is performed by abrading the other surface of the second piezoelectric element.
